(19) United States
(12) Patent Application Publication
(10) Pub. No.: US 2003/0076953 A1
(43) Pub. Date: Apr. 24, 2003

(54) Mobile phone securing device

(76) Inventor: Hsi Kuang, Taipei (TW)

Correspondence Address: JOHNSON & ASSOCIATES, P.C., 14625 Baltimore Avenue # 282, Laurel, MD, 20707, US

(21) Appl. No.: 10/025,622

(22) Filed: Dec. 26, 2001

(30) Foreign Application Priority Data
Oct. 24, 2001 (TW) 090218187

(51) Int. Cl. H04M 1/00

(52) U.S. Cl. 379/441

(57) ABSTRACT

A mobile phone securing device includes a plate member which has a connecting member connected to an external object to be connected, and an enclosing member that is a band-like member connected to the plate member so as to form a confining space for securing a mobile phone therein.

### BACKGROUND OF THE INVENTION

1. Field of the Invention

The present invention relates to a mobile phone securing device.

2. Description of Related Art

Mobile phones make communication between people very convenient. The mobility provided by mobile phones enables people to obtain information they want any time.

There have been developed hooking type bags to facilitate carrying of mobile phones. As for use of mobile phones in a fixed manner, there are available relatively expensive devices, such as phone supporting frames and fastenable securing seats installed in automobiles. These devices are not only expensive but also inconvenient to install. Now that many countries have rules prohibiting use of hand-held mobile phones during driving, the securing of mobile phones during driving is an important subject in the field.

### SUMMARY OF THE INVENTION

The primary object of the present invention is to provide a mobile phone securing device to overcome the drawbacks associated with the prior art.

### BRIEF DESCRIPTION OF THE DRAWINGS

The foregoing and other features and advantages of the present invention will be more clearly understood from the following detailed description and the accompanying drawings, in which,

FIG. 1 is a perspective view of the present invention;

FIG. 2 is a schematic perspective view of the present invention in a state of securing a mobile phone;

FIG. 3 is a schematic view illustrating that the present invention is adapted to be connected to a helmet; and

FIG. 4 is a schematic view of the preferred embodiment in a state of use.

### DETAILED DESCRIPTION OF THE PREFERRED EMBODIMENTS

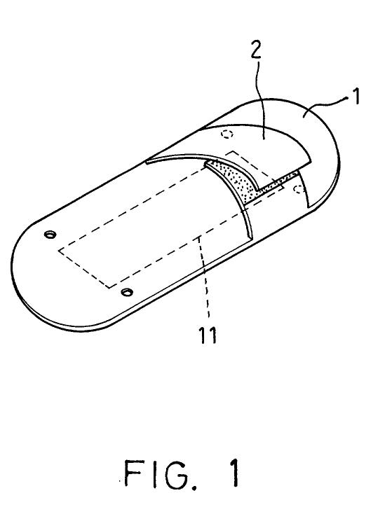

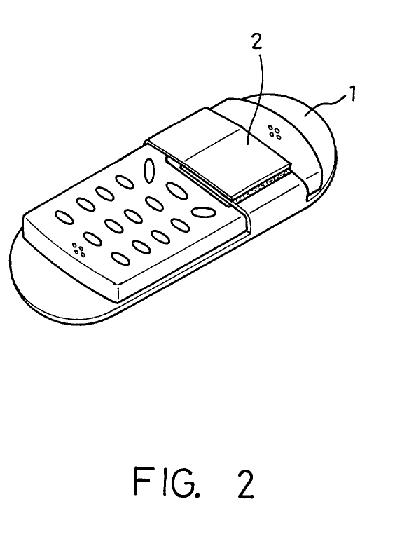

Referring to FIGS. 1 to 4, a mobile phone securing device according to the present invention essentially includes a plate member 1 and an enclosing member 2.

The plate member 1 is a thin plate that is shaped to match a mobile phone and that can serve as a support member. In order that the plate member 1 can connect with an object to be connected, the plate member 1 is provided with a connecting member 11 which can be an adhesive 11 provided on a backside thereof or a hole in the plate member 1 for passage of a screw therethrough.

The enclosing member 2 is a band-like member. There may be at least one, two or more enclosing members 2. The enclosing member 2 is formed from an elastic material with two ends respectively connected to the plate member 1 so as to form an enclosure of a predetermined shape. The enclosing member 2 may be a band-like hooks-and-loops fastener with ends respectively secured to the plate member 1 and central portions in an overlapping and engaging state, and forms an enclosure after placement of the mobile phone.

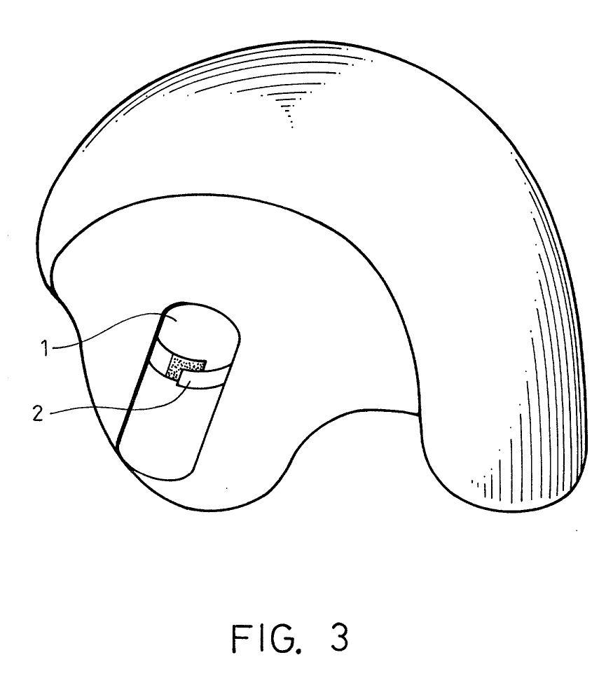

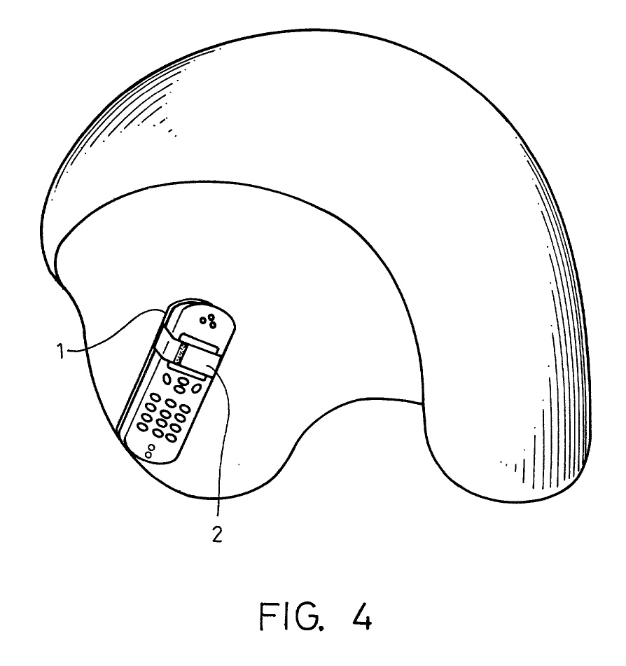

With further reference to the drawings, since the plate member 1 is provided with a connecting member 11, it can be connected to an inner wall of a safety helmet near the ear of the user, such as that shown in FIGS. 3 and 4, or near the cheek of the user so that the user can use the mobile phone in a hand-free state.

By virtue of the present invention, the mobile phone can be better secured. Besides, the present invention is less costly, and is simple to use.

Although the present invention has been illustrated and described with reference to the preferred embodiment thereof, it should be understood that it is in no way limited to the details of such embodiment but is capable of numerous modifications within the scope of the appended claims.

What is claimed is:

1. A mobile phone securing device, comprising:
a plate member having a connecting member that is connectable to an external object to be connected; and
an enclosing member which is a band-like member connected to said plate member so as to form a confining space for securing a mobile phone therein.

2. The mobile phone securing device as claimed in claim 1, wherein said connecting member of said plate member is an adhesive provided on a backside thereof.

3. The mobile phone securing device as claimed in claim 1, wherein said connecting member of said plate member is a hole for passage of a screw therethrough.

4. The mobile phone securing device as claimed in claim 1, wherein said enclosing member includes two hooks-and-loops fasteners each of which has one end secured to said plate member and another end overlapping and engaging each other.

5. The mobile phone securing device as claimed in claim 1, wherein said enclosing member is an elastic band with two ends secured to said plate member.
